(19) United States
(12) Patent Application Publication
(10) Pub. No.: US 2023/0325133 A1
(43) Pub. Date: Oct. 12, 2023

(54) Control architecture to support 3D printers enabling a Production Network

(71) Applicant: INDUSTRY SUPPLIES, INC., Newark, DE (US)

(72) Inventor: Martin D. Fiumura, Buenos Aires (AR)

(21) Appl. No.: 18/297,077

(22) Filed: Apr. 7, 2023

Related U.S. Application Data
(60) Provisional application No. 63/328,580, filed on Apr. 7, 2022.

(51) Int. Cl. G06F 3/12; B29C 64/393

(52) U.S. Cl. CPC G06F 3/126; B29C 64/393; G06F 3/121; B33Y 10/00

(57) ABSTRACT

Method, system, and apparatus for a Production Network used in Additive Manufacturing and, more particularly, a modular Print Array of additive manufacturing Print Units, Electronics Modules, and Feeding and Drying Systems, which are capable of supporting a production workflow with no downtime due to centralized monitoring and control.

### FIELD OF THE INVENTION

This invention relates to a 3D additive manufacturing system's Array. The Print Array architecture is devised to support and manage scalable part production by relying upon a control architecture between the different elements of the Print Array to deploy a Production Network.

### BACKGROUND OF THE INVENTION

Over the decades, additive manufacturing (AM) has matured into a reliable technology with a great variety of equipment and advanced software options. Faster machines, better materials, and smarter software are helping to make AM a realistic solution for many real-world production applications. As processes have matured and materials science has accelerated, additive manufacturing is now used throughout the full production cycle complementing traditional manufacturing processes.

AM technology is now proven, well-understood and established as a manufacturing method across many industry sectors. The key standards have been developed, enabling repeatable quality at scale. AM systems offer several benefits, including increased flexibility, independence, as well as time and cost savings.

Industrial 3D printing systems have been developed as complex technical equipment, which requires technical training to develop practical operation and maintenance skills. Taking into consideration the organization's need for early-stage adoption and scalability, the present invention aims at making more efficient operation, maintenance, technical services to 3D printing systems so to reduce downtime, and thus maintenance and training costs.

The main obstacle preventing the adoption of 3D printers into an industrial manufacturing process is the lack of a workflow from prototyping to scalable production. In fact, companies use 3D printers as stand-alone equipment in which they prototype and also manufacture the final parts they need in low volume batches. A target company may purchase a few units to cover the production needs by operating each unit individually.

On one side, the R&D team requires the agility to iterate prototypes and finalize the design for each component. On the other side, the procurement team has to develop the supply chain, and thus determine whether to convert the designs onto another manufacturing process (with great cost and lead time) or, if manufacturing with 3D printers is possible for that application, to purchase more 3D printers to meet the production needs. No 3D printer product line offers a real solution to solve both the needs of the R&D team and those of procurement.

Providing a path to an additive manufacturing Production Network requires hardware, electronics, control protocols and software. This patent covers the control architecture for the print/manufacturing node, the Production Network.

### SUMMARY OF THE INVENTION

Process development is based on the system architecture of the 3D printer being used. The critical machine elements are the XY motion system, hotend, nozzle geometry, filament drive system, chamber heating, and filament drying. Related variables material type and size are either determined by the machine requirements.

The current state-of-the-art Stratasys FDM systems are typical. On one hand, the F370 prototyping system is based on MakerBot technology, has limited materials, and is priced for departmental use at less than $50,000. On the other hand, their industrial model Fortus 450MC is based on older Stratasys technology and has a more extensive range of materials and is priced at around $160,000-220,000.

The issue with the use of these machines is that they share very little in architecture; like they were created by different companies. An engineer creating functional prototypes on the F370 has to redo that development effort on the production machine to scale.

These are all impediments to the creation of a true digital workflow. The node-based 3D printing is a structural difference, that requires a new control protocol and results in a network-based production: the Production Network.

Interoperability at this level enables not just distributed control of a machine, but distributed production.

The design of the Print Array's control architecture enables remote use and control of a mass installation of Print Unit capacity. It is the core of the Production Network. The Print Array distributes control to allow maximum flexibility to manage additive and traditional technologies. The central CPU supports the computing needs of generic APIs for a Production Network. Offloading these CPU cycles to a non-real-time system is required for precise control.

### BRIEF DESCRIPTION OF THE DRAWINGS

Further features and advantages of the invention will become apparent from the following detailed description taken in conjunction with the accompanying figures showing illustrative embodiments of the invention, in which:

FIG. 1 is a perspective view of a Single Print Unit for prototyping in accordance with the present invention.

FIG. 2 is a perspective view of a Print Array unit featuring one-to-one matchup of Electronics Module (2) to Print Unit (1) and Feeding and Drying Module (3) in accordance with the present invention.

FIG. 3 is a perspective view of a motion module of a Single Print Unit (FIG. 1) without outer panels, featuring the integrated Electronics Module (4) in accordance with the present invention.

FIG. 4 is a perspective view of a Print Unit Module of a Print Array (FIG. 2), featuring an electrical keying fast-locking connector at the end of the cabling bundle (5) in accordance with the present invention.

FIG. 5 is a perspective view of Print Array Host showing a set of modules comprising a Print Unit (6), an Electronics Module (7), and a Feeding and Drying Module (8) sliding-in in accordance with the present invention.

FIG. 6 is a lateral view of an Electronics Module without lateral panel showing the electronics architecture, including a Control Hardware Mainboard (CHM) (10), a Single Board Computer (SBC) (9), a Built-In Power Supply (11), a keying electrical connector (12) in accordance with the present invention.

FIG. 7a is a perspective front view of an Electronics Modules featuring and handle (16), a power button (17), and a display (18).

FIG. 7b is a perspective rear view of an Electronics Modules featuring a power plug (14), and an industrial 108-pin connector (15).

FIG. 8 is a perspective front view of a Print Unit and its associated Electronics Module within the Print Array Host.

FIG. 9a is a perspective view of a Print Unit's components including the XY motion system (24), filament drive system, chamber heating system (20), Z motion system (21), air-flow system (23), and insulation (19).

FIG. 9b is a front view of a Print Unit's components including the XY motion system (24), hotends (25), nozzle geometry (25), filament drive system, chamber heating system (20), build platform (22), and air-flow system (23), in accordance with the present invention.

FIG. 10 is a perspective view of a Print Array Host featuring an internal CPU (27) and a Router (28) in accordance with the present invention.

FIG. 11 is a perspective schematic view of a Feeding System up to the extruders in the Print Array Host (32) featuring electronics (30), a Drying Module (29), and two Buffers (31), in accordance with the present invention.

FIG. 12 is a diagram showing the communication among the elements of each 2×2 parallel sets of modules with Material Handling System and to and from the Internal CPU (27) and the Internal Router (28) in the Print Array Host, in accordance with the present invention.

### DETAILED DESCRIPTION OF THE INVENTION

DEFINITIONS

| | |
|---|---|
| PU or Print Unit | Print Unit or the modular 3D printing module. Also, a measure |
| | of production capacity (e.g. a Prototyping Unit = 1 PU; |
| | a Production Machine = 4 PUs) |
| SPU or Single Print | Prototyping Unit |
| Unit | |
| PA or Print Array | Production Machine or PM |
| PAH or Print Array | Empty Production Machine, no PUs or EMs |
| Host | |
| EM | Electronics Module |
| PN | Production Network or network that these various print |
| | capabilities use for communications and control |
| Node | A generic print node connected a Prototyping Unit or |
| | Production Machine attached to a Production Network |
| DRM | Digital Rights Management |
| Control CPU | Central non-real-time controller that manages a PA. SPUs do |
| | not have a Control CPU. |

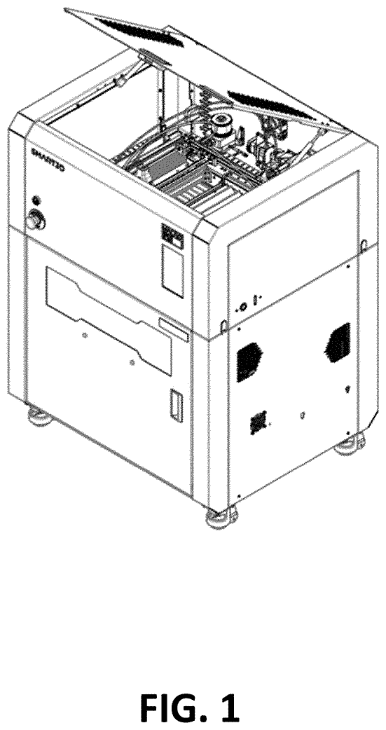

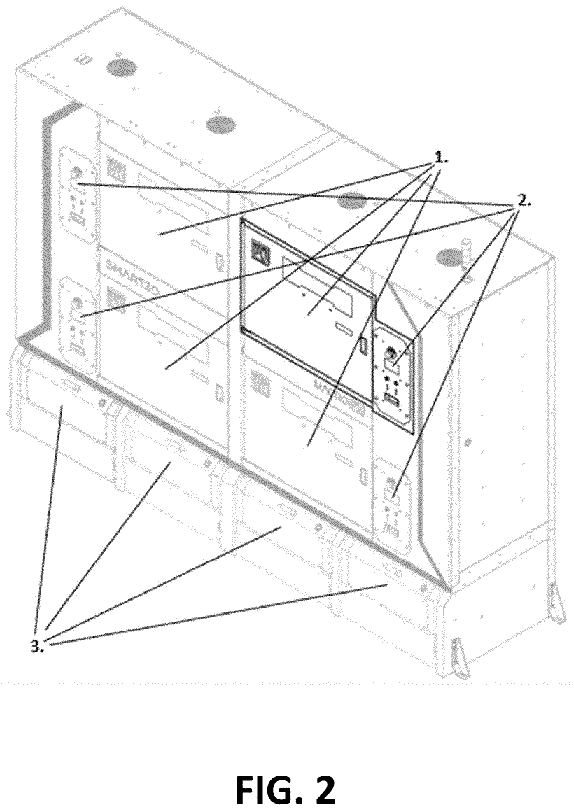

The systems of the present invention were designed for different users, spaces and applications for additive manufacturing. The Single Print Unit (SPU) (FIG. 1) is a prototyping machine to be used by a designer or engineer at an office to rapidly iterate on the different stages of product development. The Print Array (Production Machine) (FIG. 2), on the other hand, is a production machine meant for the manufacturing of tools, fixtures and end-use parts, among others, typically on the factory floor.

These users and setups have different needs. While a designer at an office may see material drying, print queuing, on-screen slicing, automatic material backup and others as “nice-to-have” features, for a production engineer running a batch of hundreds or thousands of parts at a factory they significantly lower labor, downtime, and risk of failure.

For prototyping and first adoption, Single Print Unit (FIG. 1) is a self-standing equipment. The Print Array system (Production Machine) is a fundamental structure populated with sets of interchangeable modules. In the present invention, Production Machines (FIG. 2) are Print Array systems in 2×2 or larger arrays of Print Units to provide consistent, scalable motion and print control.

The novelty of the present patent is the modular structure of the sets in the Print Array product line. More specifically, the comprehensive integrated control architecture of the Single Print Unit (FIG. 1) and the Production Machine (FIG. 2). The new technical modular system of the present invention enables a Production Network using a unique interface architecture. The modular architecture gives redundancy to the Production Machine (FIG. 2) in case of failure of one or more modules.

The design of the Print Array control architecture enables remote use and control of a mass installation of Print Unit capacity. The core of the Production Network relies on unique multi-level electronics architecture. The distributed control allows maximum flexibility to manage both additive and traditional manufacturing technologies.

In the preferred embodiment of the present invention, Fused Filament Fabrication (FFF) is the 3D printing technology deployed. In another embodiment, interchangeable modules can include all types of additive manufacturing equipment, as well as traditional manufacturing, inspection and scanning technologies.

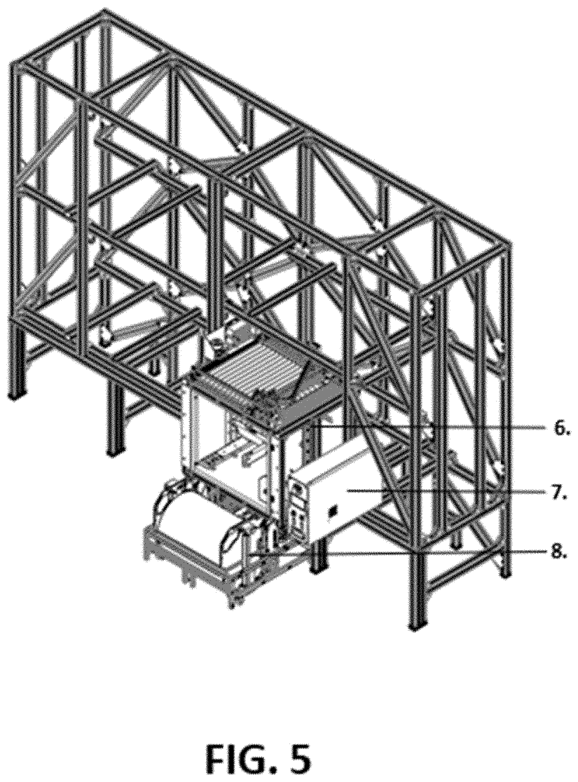

Production Machines consist of a sturdy aluminum framing structure, which contains 2×2 modular sets. These sets are composed by one Print Unit module (6), one Electronics Module (7), and one Feeding System (8) (FIG. 5). In an embodiment of the present invention, the Production Machine (FIG. 2) includes material Feeding and Drying systems (8) and an internal CPU. In another embodiment of the present invention, according to the technology deployed, the Production Machine (FIG. 2) can support other ancillary equipment modules, such as annealing systems, vacuum systems, ultrasonic resin cleaner, support removal systems.

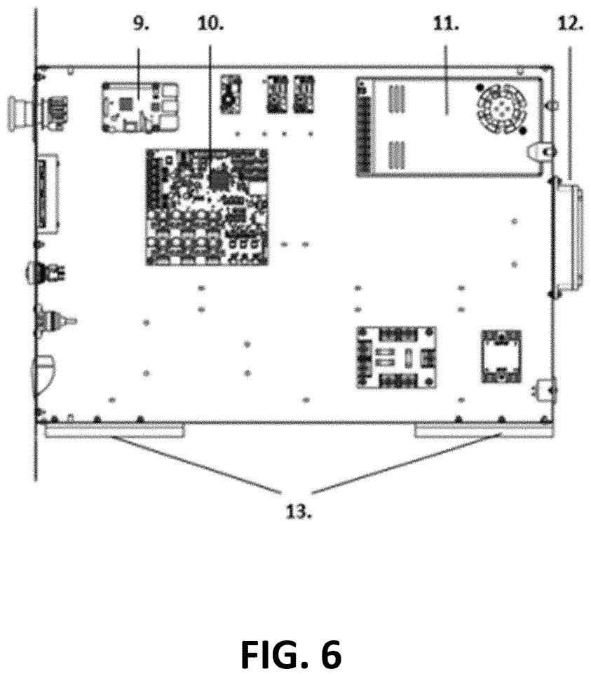

The design of the motion module is used both in the Single Print Units model (FIG. 4) used for prototyping and in the Print Array product line (FIG. 1). Single Print Units (4) share the same electronics configuration with the Electronics Module (FIG. 6) of each Print Unit within the Production Machine (FIG. 2). These electronics module elements are modular and interchangeable.

Single Print Units (FIG. 1) are tools for designers and engineers working on different phases in the product life-cycle, such as product development, design iterations, process optimization, material testing and validation, development and production of manufacturing aids, and spare parts, among others. They enable the creation of a digital inventory, which is the source used at the factory to efficiently select, automate and scale a production process within common material sets and configurations.

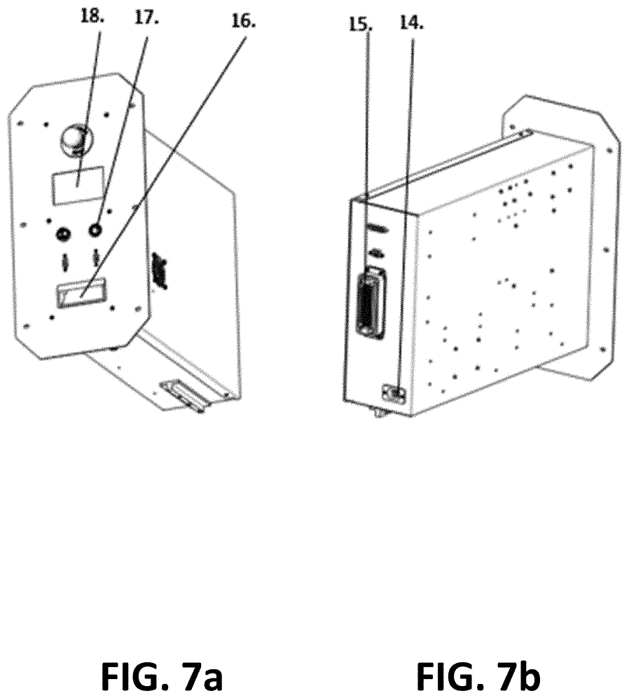

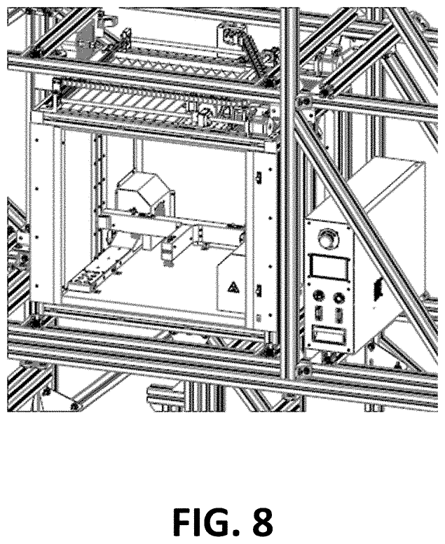

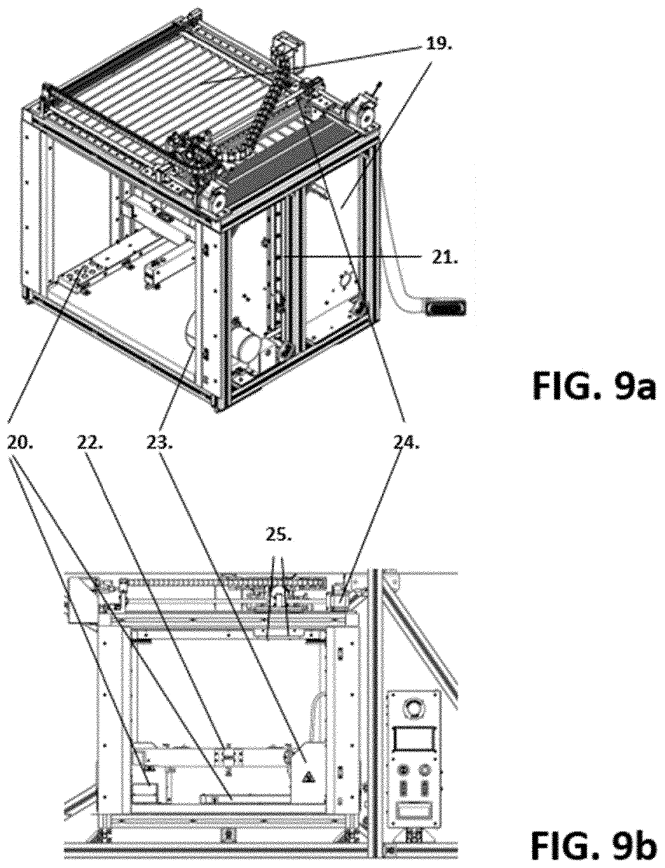

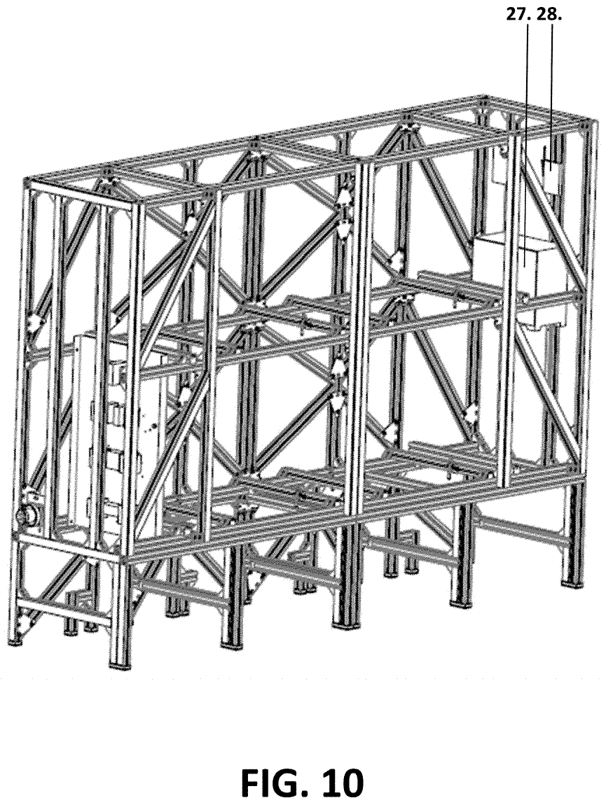

These Single Print Units (FIG. 1) are low-cost devices which accelerate the production of each iteration of a prototype, avoid the need for outsourcing with their external quoting requirements and supply chain bottlenecks, reduce lead times, and make every part they process ready for internal production and scale. Each Print Unit (FIG. 1) in the Print Array has an Electronics Module (FIG. 7a, FIG. 7b) arranged next to the individual Print Unit (FIG. 8), which supports any combination of variable Print Unit features.

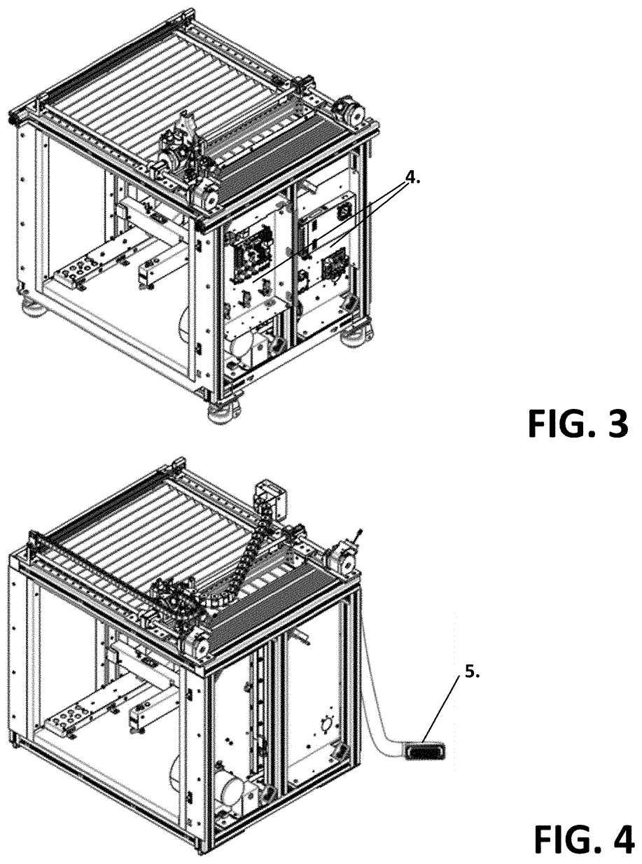

Single Print Units (FIG. 3) have an integrated electronics architecture which is not removable (4). Single Print Units (FIG. 1) share the same electronics configuration (4) with the Electronics Module (FIG. 6) powering each Print Unit within the Print Array. The same design of the Electronics Module is used both in the Single Print Units (4) model used for prototyping and in the Electronics Module (FIG. 6) powering the Print Unit (FIG. 4) for the Print Array (FIG. 2) product line for production floors.

Single Print Units (FIG. 1) may be a simplified version of the Print Units (FIG. 4) present in Production Machines (FIG. 2). Their core architecture shall not differ, as material compatibility, precision, and speed need to be identical for the transparent transition between prototyping and production. But ancillary features such as material drying, automatic feeding, material backup, Print Unit management or the facilitated replacement of Print Units or Electronics Modules are not required, favoring lower capital investments in the product validation phases of the product lifecycle.

The Cloud/Local Host, the control CPU, and the Electronics Module are the three main components of the Production Network logic architecture.

### Cloud/Local Host

The Cloud/Local Host is a physical or software abstraction located within the company's firewall or in an air-gapped environment to provide secure and efficient network functions. A Local Host can be set up internally or externally to other Smart3D systems. It enhances network operations in a factory, a syndicated organization, or any other type of business.

In the preferred embodiment of the present invention, the Production Machine has a built-in Router (28). The internal Router (28) connects to Electronics Modules (2) and material Feeding and Drying Systems (3) in the Print Array.

The internal Router (28) can be configured to connect to an external NAT server, router, or switch. The Production Machine router (28) supports either static or dynamic IP address configurations for each module. The Production Machine (FIG. 2) is connected to the user's network via LAN, Ethernet, or Wi-Fi, according to local security requirements.

Once connected, all modules in the Print Array Host (FIG. 2) can be operated and visualized via remote connection via IP or local host. Each module self-identifies on this Production Network as an individual addressable and controllable print node. Thanks to the logical interface handshake protocol, this node-based 3D printing creates a new control protocol and sets the foundations for a network-based production, based on a true digital workflow.

The Electronics Module (2) sets global address and type for network, and reads nozzle size for the Print Unit (1), material type from the material feeding system, and Print Unit's performance offsets. The common logical interface enforced this way also opens up generic APIs to address and control network printers.

When a Print Unit (FIG. 4) requires maintenance, the module (6) is removed from the Print Array (FIG. 5) together with its offset and calibration data stored in its dedicated SD card in the Electronics Module (7). This reduces production downtime by rapidly replacing a unit needing maintenance with another one ready for service with its offset and calibration data.

### Control CPU

On Print Array machines (FIG. 2), a central CPU (27) maintains the Production Network. Each Production Machine (FIG. 2) comes with a computer (CPU) (27) supporting non-real-time controls and job control to and from the Production Network. Offloading these CPU cycles to a non-real-time system guarantees precise control of all sets of modules (FIG. 5). The CPU (27) receives real-time information to display for the user from the modules in the Print Array (FIG. 2), while each module performs the non-real-time tasks in the background.

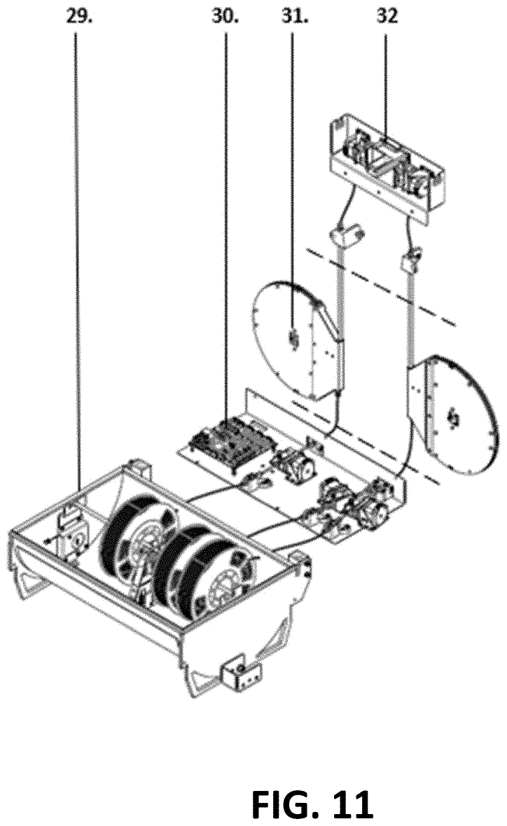

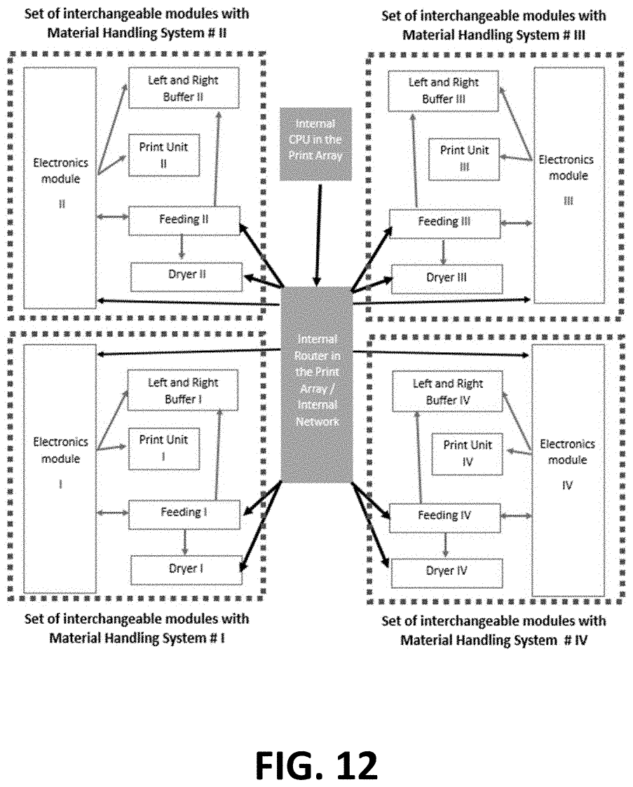

Through the CPU (27), operators can access Print Units (1), and Feeding and Drying Systems' (FIG. 11) command console to execute G-code commands and report printing parameters, such as offsets, temperature, fans or data from the Feeding Systems electronics (30). It also polls data to and from the low bandwidth controls of the Feeding and Dryer Systems (30), as well as the filament-switching Buffer system (31).

The central CPU (27) executes control commands over a network connected either via Ethernet or Wi-Fi. It handles security protocols with the Cloud/Local Host and data collection generated from the production workflow. In the Print Array (FIG. 2), it is responsible for handling all the computing needs of the various APIs that allow for control and management of each set of modules (FIG. 5).

The CPU (27) is also capable of processing slicing for all its 2×2 chambers and generating G-codes. It can also process and enforce Digital Rights Management for parts printed across the Production Network.

The CPU (27) can poll data from the Electronics Modules (2), such as status, IT, reporting, analytics, and production operations statistics. It can format this information to be utilized for the Production Network. The advantage of managing the Production Network from a centralized control reduces unwanted complexity and ensures that all relevant aspects of the production workflow are controlled and aligned to the needs of the company.

In another embodiment, the Production Machine (FIG. 2) is combined with a management software. The management software supports a great variety of features as needed, such as centralized file system, shared print queue, multi-user, and advanced analytics for streamlining production workflow. As an example, the management software receives and distributes G-code files to the print queue according to variables such as loaded material, quantity of available material, priority level, etc.

In the preferred embodiment of the present invention, the control CPU (27) self-identifies to the Production Network, pulls jobs from Single Print Units (1), negotiates capabilities and availability of the Production Network's components, handles local queuing, and manages the interrelationship within the Print Array work. For instance, it can run a scan module after printing, send parts to Print Units (1) in order of need, and managing and aggregate production capacity in a local Print Array (FIG. 2) and, as well as on other available systems within the Production Network.

### Electronics Module

Electronics Modules (2) in the Print Array are modular and slide-out interchangeable subassemblies (FIG. 7a, FIG. 7b). Electronics Modules consist of a metal cabinet containing all electronics components (FIG. 6) of a Print Unit.

Each Electronics Module (2) is located in proximate distance (FIG. 8) to the individual Print Unit (1) and supports all variable combinations of Print Unit features. Each Electronics Module (2) controls only the Print Unit (1) to which it is associated and physically connected via an electrical connector (5, 12, 15). The Electronics Module's local computer power resources are only for print control of the Print Unit it is associated with.

The Electronics Module (2) collects Print Unit (1) config data. When a Print Unit (1) requires maintenance, the print module (6) is removed from the Print Array together with the dedicated SD card storing its offset and calibration data within the associated Electronics Module (7).

Each Electronics Module provides power to one Print Unit components, such as motors, heating system, cooling circuit. It passes through status information and controls switches in the Buffers (31) and material Feeding and Drying System (FIG. 11). While pushing status information to the Central CPU (27), it provides control and logic signals, as well as providing and receiving data from sensors in Print Units (1) and Feeding and Drying Systems (3).

On a Single Print Unit (FIG. 3) system used for prototyping, the Electronics Module (4) is electrically the same as the interchangeable Electronics Module (FIG. 6) in the Print Array (7) and contains the same components. In the preferred embodiment of the present invention, the Electronics Module (FIG. 6) includes, among others, a Control Hardware Mainboard (CHM) (10), a Single Board Computer (SBC) (9), a Built-In Power Supply (11), a fast-locking keying electrical connector (12), and a power plug. It also supports RFID, Bluetooth, Bluetooth-LE, IoT interface for logic expansion.

The CHM (10) stores the unit firmware dedicated to movement controls and motor drivers. It also manages all sensors in the Print Unit (1) and up to the filament Buffer (31), such as temperature, proximity, humidity, end-of-filament, or any other supported sensors. It is connected to an SBC (9) and can be controlled directly or remotely over a network.

The SBC (9) provides the user interface via a browser-based control application. It also provides a network interface via the local network or VPN, depending on how it is configured. It processes G-codes and can be programmed for additional networking and third-party program options. It communicates with the CHM (10), provides a webserver for web control, APIs for third-party applications, and a plugin interface specifically for G-code processing plugins. The SBC (9) also stores all offset and calibration values of a Print Unit on a dedicated SD card. Machine performance offsets that are stored with each Print Unit (1) are interpreted in the Electronics Module (2) to provide consistent printing performance.

The electronics architecture supports future expansions and a wide range of sensors and features. Each Print Unit (1) within the Print Array (FIG. 2) can support different characteristics. Such variable features include, among others, extrusion and chamber temperature, single or dual extrusion, and insulation for printing a greater variety of engineering and high-performance polymers. The use of the same Electronics Module (2) to support variations of print modules (1) provides consistency and code compatibility, as the same parameters are used on the same module across different platforms. It also provides network control and security. Security protocols with the Cloud/Local Host and data collection generated from the production workflow are handled by the Central CPU (27) in the Production Machine (FIG. 2).

The Electronics Module (FIG. 6) can be designed to provide control for a wide range of machines, including but not only 3D printers, CNCs, laser cutters, and traditional manufacturing equipment. The electronics architecture of the present invention allows maximum flexibility of machine design through highly capable mainboards, expansion boards, smart tool boards and custom expansion modules which can be included within the Electronics Module (FIG. 6) as needed.

### Print Unit Module

The Print Unit (FIG. 4) element consists of a sturdy aluminum structural framing structure containing the whole motion system and 3D printing elements of a Prototyping Unit (FIG. 3). This includes, among others, the XY motion system (24), hotends (25), nozzle geometry (25), filament drive system, chamber heating system (20), build platform (22), Z motion system (21), air-flow system (23), and insulation (19). It can also include, among others, direct extrusion system, any relevant sensor, fiber, liquid or gas, or any other kind of material application system.

Each Print Unit Module (1) is commanded by its assigned Electronics Module (2). The latter contains enough electronics to distribute power and exercise control of the whole Print Unit's motion system. It also contains the control sensors that pass through it to the Control CPU (27) for status or runtime. Each Print Unit config data and machine offsets are stored on an SD card in the Electronics Module (10) it is associated with. Businesses can set the configuration of their Production Network according to their production needs, by choosing Print Units' hotend type, nozzle configuration, calibration, and material settings. Reporting information such as machine offsets and runtime are stored within the Electronics Module (2) of each Print Unit (1).

### Material Handling/Feeding System

In the preferred embodiment of the present invention, each Print Unit operates in conjunction with a dedicated material Feeding and Drying Module (FIG. 11) located at the bottom of the Print Array Host (FIG. 2). Each Feeding System also supports a material Drying System. The material Drying System (29) maintains polymers at controlled conditions, such as moisture content or temperature. The material Drying System (29) includes a great variety of sensors and functions, such as material backup, filament-runout sensor, active moisture control, and other sensors for monitoring, reporting and statistics.

Each Feeding and Drying System (3) pushes the material up to two dedicated Buffers (31) in the Print Array Host, on Buffer for each Print Unit nozzle. The Buffer (31) system handles the material feeding distance between the spools in each Feeding and Dryer System (29) and the extruders in each Print Unit (32). In the preferred embodiment of this invention, the Buffer (31) is mechanical.

Each Feeding and Drying System (FIG. 11) is controlled by a dedicated Control Hardware Mainboard (CHM) (30). The CHM (30) operates as a programmable logic controller. It receives input data from sensors and sends operating instructions to switches commanding motors, vacuum pump, and heating system in the Feeding and Drying System (FIG. 11).

The CHM (30) in the Feeding and Dryer System receives data also from the two filament sensors in each Buffer (31) to activate or deactivate the motors in the Print Unit Feeding System (32). The Buffer (31) is controlled by each Electronics Module (2), where it can be programmed to manage multiple materials or support several options.

The Feeding and Drying System (FIG. 11) can be programmed to either automatically operate according to the loaded material, or manually by the user. It pushes data to the internal router and the central CPU (27), as well as to and from the Dryer (29), such as material type, remaining available material, drying status, filament switching status, and filament back-up.

### Monitoring

Finally, the Production Network supports a centralized monitoring system. In monitoring and supervision schemes, fault detection and diagnosis characterize high efficiency and quality production systems. The monitoring and supervision of processes aim to show the real state of the equipment involved in a productive process, indicating undesirable or illicit states and the appearance of a change in its initial phase (early failure).

The continuous reporting of the systems within the Production Network enables detection and diagnosis of failures in real time. Fault detection is based on signal and process modeling. Monitoring and supervision complement each other in fault management, thus enabling normal and continuous operation.

These inputs facilitate intelligent monitoring and supervision systems, enabling real-time fault detection and diagnosis. Consequently, production environments can avoid stopping productive processes by detecting failures early and by applying real-time actions to avoid them, such as predictive and proactive maintenance based on process conditions.

Particularly, the modular architecture of the Production Machine (FIG. 2) minimizes the impact of lack of maintenance or reduced maintenance on the equipment. In fact, preventative maintenance can be scheduled and performed by simply removing and swapping single modules, either Print Units (1), Electronics Modules (2), or Feeding and Drying Modules (3).

The centralized monitoring system also enables user management features. It allows administrators to manage users, assign roles, and control access to resources within the system. This improves security, reduces the complexity of managing tasks across multiple systems, and enables the management of different levels of user access and permissions.

Thanks to the centralized monitoring, maintenance can be planned by analyzing the performance indicators and identifying the root cause of the failures and the degradation of the equipment. Each module (1, 2, 3) in the Print Array can be removed before the severity of a fault increases, potentially compromising the production workflow.

Each module (1, 2, 3) can be replaced with a spare unit within a few minutes. Once removed, modules can be conveniently serviced and repaired in a technical laboratory on premise or sent to an outsourced technical service. This process guarantees both minimal downtime and cost savings for any business.

The foregoing describes the preferred embodiment of the invention and sets forth the best mode contemplated for carrying out the invention in such terms as to facilitate the practice of the invention by a person of ordinary skill in the art. However, it is to be understood that the invention has many aspects, is not limited to the structure, processes, methods, and embodiment disclosed and/or claimed, and that equivalents to the disclosed structure, processes, methods, embodiment, and claims are within the scope of the invention as defined by the claims appended hereto or added subsequently.

Although the present invention has been described herein with reference to the foregoing exemplary embodiment, this embodiment does not serve to limit the scope of the present invention. Accordingly, those skilled in the art to which the present invention pertains will appreciate that various modifications and equivalents are possible, without departing from the technical spirit of the present invention.

1. An industrial 3D printing device wherein a Print Array Host houses 2×2 or larger sets of modules, each set comprising the following interchangeable elements:
one Print Unit module;
one Electronics Module;
one Feeding and Drying System.

2. The apparatus according to claim 1, wherein the Print Array Host enables a scalable Production Network thanks to a unique multi-level control architecture between the Print Array Host and the other Production Network's elements comprising:
modular Print Units;
Electronics Modules;
a Cloud/Local Host;
a Control CPU;
material Drying Systems;
material Feeding Systems;
a centralized Monitoring System.

3. The apparatus according to claim 1, wherein a Print Unit:
is associated with and physically connected to an Electronics Module;
has user-controlled or sensed Print Unit configuration of hotend type, nozzle configuration, and calibration settings;
has sensors that pass-through information to the Control CPU for status.

4. The apparatus according to claim 1, wherein an Electronics Module:
is associated with and physically connected to a Print Unit;
includes enough electronics components to distribute power and execute controls to the motion system of the Print Unit it is associated with and connected to.
is responsible for real-time control of the Print Unit it is associated with and connected to;
passes through status information and dryer/switcher control;
pushes status information to the Central CPU when free;
stores configuration data and calibration offsets of the Print Unit it is associated with and physically connected to.

5. The apparatus according to claim 1, wherein each Material Feeding and Drying System uses user-controlled or sensed material configuration, controlling and reporting the following data to the central CPU in the Print Array:
material type;
remaining available material;
filament switching status;
drying status.

6. The method wherein the Cloud/Local Host is a physical or software abstraction located inside the firewall or air-gapped, which provides the distributed capability of Production Networks and network functions inside a factory, company, or syndicated organization, being either internal or external to the Print Array.

7. The method according to claim 6, wherein the Control CPU on Production Machines maintains the Production Network by:
handling security protocols with the Cloud/Local Host;
handling data collection generated from the production event;
processing and enforcing Digital Rights Management for parts;
polling the Electronics Modules for status;
driving the low bandwidth controls of the Material Feeding and Drying Systems;
formatting and presenting the data received for a centralized monitoring system of the Production Network.

8. The method according to claim 6, wherein the internal CPU's cycles are offloaded to each set of modules as a non-real-time system for precise control of the Production Network.

9. The method according to claim 6, wherein the Control CPU:
self-identifies to the Production Network;
pulls jobs from Single Print Units;
negotiates capabilities and availability of the Production Network's components;
handles local queuing;
coordinates interrelationships within Print Array work, including:
running a scan module after printing;
running parts in order of need;
aggregating production capacity in the local Print Array and in other available systems.

10. The method according to claim 6, wherein the centralized Monitoring System receives information from the other elements in the Production Network for diagnostics, fault reporting and user management.
